(19) United States
(12) Patent Application Publication
(10) Pub. No.: US 2005/0234602 A1
(43) Pub. Date: Oct. 20, 2005

(54) Service database with component images

(75) Inventor: Stephen K. Rigsby, Conway, AR (US)

Correspondence Address: MCDERMOTT WILL & EMERY LLP, 600 13TH STREET, N.W., WASHINGTON, DC, 20005-3096, US

(73) Assignee: SNAP-ON INCORPORATED

(21) Appl. No.: 11/104,550

(22) Filed: Apr. 13, 2005

Related U.S. Application Data
(60) Provisional application No. 60/562,611, filed on Apr. 16, 2004.

(51) Int. Cl. G05D 1/00

(52) U.S. Cl. 701/1

(57) ABSTRACT

A vehicle service database includes a work order data structure listing at least one component to be serviced, installed, replaced, or repaired. The vehicle service database also includes an image data structure for representing a digital image of the at least one component. The service technician uses an imaging device to photograph one or more components. The resulting images are stored in the database or other file system to provide visual confirmation or proof that the work has been performed. Further features and advantages, such as transmitting an image to an insurance provider, are also provided.

### RELATED APPLICATION

This application claims the benefit under 35 U.S.C. §119(e) of U.S. Provisional Patent Application No. 60/562,611 filed on Apr. 16, 2004, entitled “Service Database with Component Images” which is incorporated by referenced herein its entirety.

### TECHNICAL FIELD

The present disclosure relates generally to customer databases for service industries, and more particularly, to the acquisition and storage of vehicle component images in a database.

### BACKGROUND

A typical automotive or vehicle service facility uses computer software to maintain a database of customer information and service history. Generally work orders are entered into the database in order to track the progress of the technician's work and to provide accurate billing or invoice information to the customer.

Although conventional work order tracking and database systems provide detailed information about the work performed and associated cost, the paying party (e.g., the customer or the insurance company) may nevertheless dispute that certain work was performed. One conventional approach to this problem is to show the customer the replaced components or parts. A drawback to this approach is that the customer (e.g., an insurance company representative) may not always be physically present to view the replaced or installed components.

Further, it may be impractical or dangerous for the customer to enter the service facility to view the damaged or replaced components. Service facilities generally discourage customers from entering the work area because of safety and liability concerns.

Conventionally, a completed work order is the only record or proof that the technician performed the requested services. If a completed work order is in fact incomplete, the service facility may be subject to liability or may lose valuable repeat business from its customers.

What is needed is a service database that integrates images of the replaced parts or other serviced components. What is further needed is a system that associates images with a work order to provide additional proof that the requested service has been performed.

### SUMMARY

In one aspect, a vehicle service database includes a work order data structure listing at least one component to be serviced, installed, replaced, or repaired. The vehicle service database also includes an image data structure for representing a digital image of the at least one component. The service technician uses an imaging device to photograph one or more components. The resulting images are stored in the database or other file system to provide visual confirmation or proof that the work has been performed.

Additional aspects and advantages of the present disclosure will become readily apparent to those skilled in this art from the following concise and detailed descriptions, wherein only exemplary embodiments are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The accompanying drawings illustrate several embodiments and, together with the description, serve to explain the principles of the present disclosure.

FIG. 1 illustrates a position determination system including a computing device.

FIG. 2 is a block diagram of the computing device of FIG. 1.

FIG. 3 illustrates an exemplary computing device including an imaging device.

FIG. 4 illustrates an exemplary work order including images.

### DETAILED DESCRIPTION OF THE EMBODIMENTS

The present disclosure is now described more fully with reference to the accompanying figures, in which several embodiments are shown.

One skilled in the art will recognize that methods, apparatus, systems, data structures, and computer readable media implement the features, functionalities, or modes of usage described herein. For instance, an apparatus embodiment can perform the corresponding steps or acts of a method embodiment.

Embodiments of the present disclosure are compatible with a variety of equipment present in vehicle service facilities, such as wheel alignment systems, frame straightening systems, engine diagnostic devices, and the like. Although the service database of the present disclosure is described below with reference to a position determination system, one skilled in the art will appreciate that the service database concepts apply to customer database systems used in conjunction with other types of equipment. In the example described below, the service database is stored in the computing device associated with the particular diagnostic system.

A. Exemplary Diagnostic System

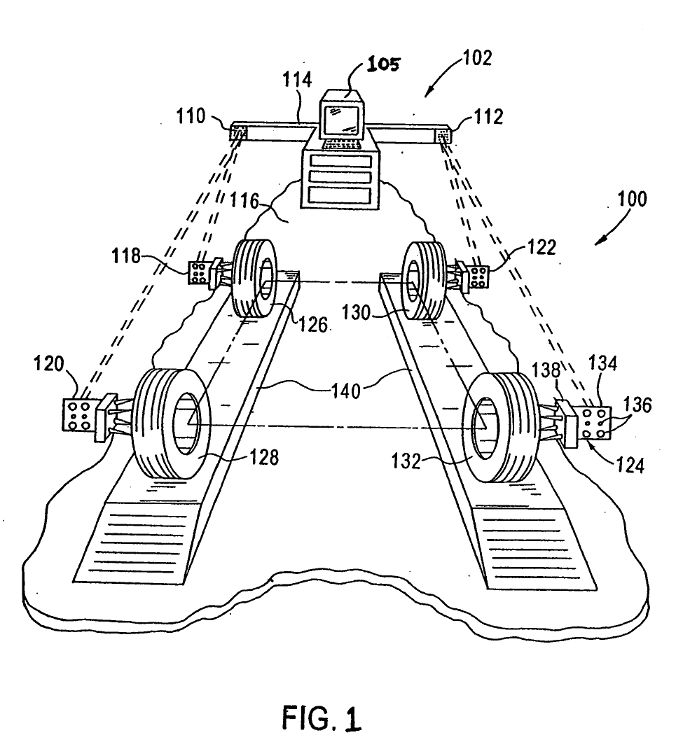

FIG. 1 illustrates an optical position determination system (e.g., an automotive wheel alignment system) including a computing device. The position determination system 100 is one example of a vehicle diagnostic system and is described briefly herein. The position determination system 100 includes a vision imaging system 102 (i.e., a data acquisition module) having a pair of fixed, spaced-apart cameras 110, 112 mounted on a beam 114. The beam 114 has a length sufficient to position the cameras 110, 112 respectively outboard of the sides of the vehicle to be imaged by the position determination system 100. Also, the beam 114 positions the cameras 110, 112 high enough above the shop floor 116 to ensure that the two targets 118, 120 on the left side of the vehicle are both within the field of view of the left side camera 110, and two targets 122, 124 on the right side of the vehicle are both within the field of view of the right side camera 112.

A vehicle under test is driven onto a lift 140. Targets 118, 120, 122, 124 are mounted on each of the wheels 126, 128, 130, 132 of the motor vehicle, with each target 118, 120, 120, 124 including a target body 134, target elements 136, and an attachment apparatus 138. The attachment apparatus 138 attaches the targets 118, 120, 120, 124 to the wheels 126, 128, 130, 132.

In operation, the targets 118, 120, 122, 124, are attached to the wheel rims and oriented such that the target elements 136 on the target body 134 face the respective camera 110, 112. Vehicle identifying information, such as the make and model year, and other customer-specific parameters can then be entered into the computing device 105 associated with the vision imaging system 102. The computing device 105 also includes a service database. The service database can include information about the work order associated with the vehicle under test.

The location of the targets 118, 120, 122, 124 relative to the rim of the wheels 126, 128, 130, 132 to which the targets are attached are typically known to an accuracy of about 0.01″ and about 0.01″. Once the targets 118, 120, 122, 124 have been imaged in one position, the wheels 126, 128, 130, 132 are rolled to another position and a new image can be taken. Using the imaged location of the targets 118, 120, 122, 124 in the two positions, the actual position and orientation of the wheels 126, 128, 130, 132 and wheel axis can be calculated by the computing device 105. Although the distance between the two positions varies, the distance is often approximately 8 inches.

The computing device 105 is coupled to cameras 110, 112 to receive the raw data (e.g., target positional signals). In practice, a mathematical representation, or data corresponding to a true image (i.e., an image taken by viewing the target device perpendicularly to its primary plane) and the dimensions of targets 118, 120, 122, 124 are preprogrammed into the memory of the computing device 105 so that, during the alignment process, the computing device 105 has a reference image to which the viewed perspective images of the target devices can be compared or using which the raw data can be processed into an alignment result.

As one skilled in the art will appreciate, the optical alignment concepts described above may also be applied to chassis or body repair. In vehicle collision repair, for example, the chassis or frame may need to be straightened, body parts may need to be repaired or replaced, and damaged mechanical parts may need to be repaired or replaced. As described in further detail below, a service technician can use an imaging device to capture digital images of one or more components to be serviced, installed, replaced, or repaired. These images can be transmitted to the computing device for storage in the service database. The computing device associates the images with the work order or specific line items of the work order to permit convenient retrieval and display. In a vehicle collision service facility, it may be advantageous for the computing device to retrieve the captured images from the service database and to provide the images to an insurance company as proof of the damages or the repair work performed.

B. Exemplary Computing Devices

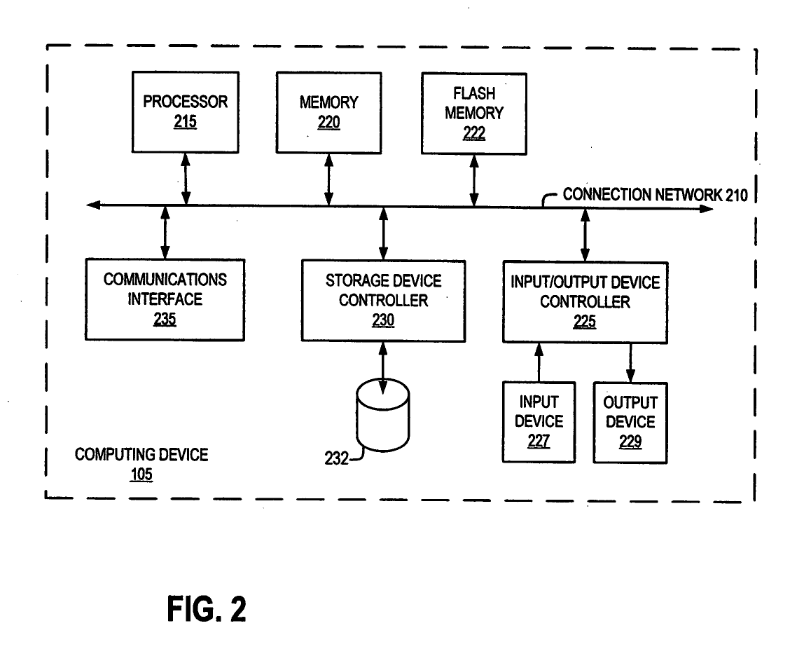

FIG. 2 is a block diagram of the computing device of FIG. 1. In the illustrated embodiment, the computing device 105 includes a connection network 210, a processor 215, a memory 220, a flash memory 222, an input/output device controller 225, an input device 227, an output device 229, a storage device controller 230, a storage device 232, and a communications interface 235. In one embodiment, the storage device 232 includes the service database stored thereon.

The connection network 210 operatively couples each of the processor 215, the memory 220, the flash memory 222, the input/output device controller 225, the storage device controller 230, and the communications interface 235. The connection network 210 may be an electrical bus, switch fabric, or other suitable interconnection system.

The processor 215 may be a conventional microprocessor. In one embodiment, the diagnostic system to which the computing device 105 is associated is portable and powered by a battery. In this instance, the processor 215 or other circuitry of the computing device 105 may be designed for low power operation in order to provide satisfactory runtime before requiring recharging or replacement of the battery.

The processor 215 executes instructions or program code modules from the memory 220 or the flash memory 222. The operation of the computing device 105 is programmable and configured by the program code modules. Such instructions may be read into memory 220 or the flash memory 222 from a computer readable medium, such as a device coupled to the storage device controller 330. In addition, instructions may be read into the memory 220 or the flash memory 222 from the communications interface 235.

Execution of the sequences of instructions contained in the memory 220 or the flash memory 222 cause the processor 215 to perform the method or functions described herein. That is, program code stored in the memory 220 instructs the processor 215 to process raw data into measurement results or other information. In alternative embodiments, hardwired circuitry may be used in place of or in combination with software instructions to implement aspects of the disclosure. Thus, embodiments of the disclosure are not limited to any specific combination of hardware circuitry and software. The memory 220 may be, for example, one or more conventional random access memory (RAM) devices. The flash memory 222 may be one or more conventional flash RAM, or electronically erasable programmable read only memory (EEPROM) devices. The memory 220 may also be used for storing temporary variables or other intermediate information during execution of instructions by processor 215.

The input/output device controller 225 provides an interface to the input device 227 and the output device 229. The output device 229 may be, for example, a conventional display screen. The display screen may include associated hardware, software, or other devices that are needed to generate a screen display. In one embodiment, the output device 229 is a conventional liquid crystal display (LCD). One skilled in the art will appreciate that many suitable technologies can be used for the display screen, for example, a light emitting diode (LED), organic LED, cathode ray tube (CRT), or a plasma display panel (PDP). The display screen may also include touch screen capabilities.

The illustrated embodiment also includes an input device 227 operatively coupled to the input/output device controller 225. The input device 227 may be, for example, an external or integrated keyboard or cursor control pad. In an automotive service environment, for example, it may be convenient for a technician to enter customer, vehicle or work order information using the input device 227. Of course, information can also be transmitted to the computing device 105 by another device such as a barcode reader or server (not illustrated). In one embodiment, the communications interface 235 receives such information and sends the information to the processor 215 via the connection network 210.

The storage device controller 230 may be used to interface the processor 215 to various memory or storage devices. In the illustrated embodiment, an internal storage device 232 is shown for storing and for retrieving, for example, program code for operating the diagnostic system, documentation, and vehicle- or customer-specific information. For example, the storage device 232 may include a service database that stores diagnostic information, images, or results for subsequent retrieval. As one skilled in the art will appreciate, the storage device 232 can be any suitable storage medium, such as magnetic, optical, or electrical storage.

The communications interface 235 provides a bidirectional data communication interface for the computing device 105. If desired, the communications interface 235 may be functionally coupled to a network, such as a local or wide area network. In one embodiment, the communications interface 235 provides one or more input/output ports for receiving electrical, radio frequency, or optical signals and converts signals received on the port(s) to a format suitable for transmission on the connection network 210. The communications interface 235 may include a radio frequency modem and other logic associated with sending and receiving wireless or wireline communications. For example, the communications interface 235 may provide an Ethernet interface, Bluetooth, and/or 802.11 wireless capability for the computing device 105.

In an embodiment, referring again to FIG. 1, the cameras 110, 112 illustrated as mounted on the beam 114 can be wirelessly interfaced with the computing device 105. More specifically, the cameras 110, 112 may be mounted on the beam 114, and the beam 114 may be disposed remotely from the computing device 105. The cameras 110, 112 can transmit images to the computing device 105, which may be a central or shop server that is located within wireless range of the cameras 110, 112. Additionally, the cameras 110, 112 may be mounted or placed in any suitable position such that images of the targets 118, 120, 122, 124 can be obtained and wirelessly transmitted to the computing device 105. The cameras 110, 112 may further wirelessly communicate with each other to determine their relative position information.

FIG. 3 illustrates an exemplary computing device including an imaging device coupled thereto. In the illustrated embodiment, the computing device 105 receives image data wirelessly from the imaging device 305 using the communications interface 235. Of course, a wireline interface may be used in addition to or instead of a wireless interface. In an automotive service facility, a wireless implementation may be advantageous for safety reasons. That is, a technician may accidentally trip over a wireline connection while photographing various components of the vehicle. On the other hand, wireless devices are typically battery powered and the batteries may fail unexpectedly during a service session.

The imaging device 305 is a conventional digital camera. In one embodiment, the imaging device is configured to produce color images including 5 megapixels (MP) of nominal resolution. As one skilled in the art will appreciate, the resolution, number of colors, data format and other parameters may be adjusted according to user preferences or data storage requirements.

In another embodiment of the present disclosure, the imaging device 305 may be a video camera. In this case, video clips can be stored in the database in order to demonstrate the work that has been performed on the vehicle. Further, the video camera can be used to broadcast or to multicast real-time video sequences for viewing via a data network. For example, a customer can watch the technician perform services with a browser over the Internet.

In a typical operation, a service technician uses the imaging device to capture digital images of one or more components to be serviced, installed, replaced, or repaired. The technician may also capture images of new components for comparison to the old, replaced part. These images are transmitted to the computing device for storage in the service database. The computing device associates the images with the work order or specific line items of the work order to permit convenient retrieval and display.

Further, it may be desirable to capture images of various vehicle parts to record preexisting damage thereof. This can be used to provide proof to the customer (or the customer's agent) that the service facility did not cause certain damages to the vehicle.

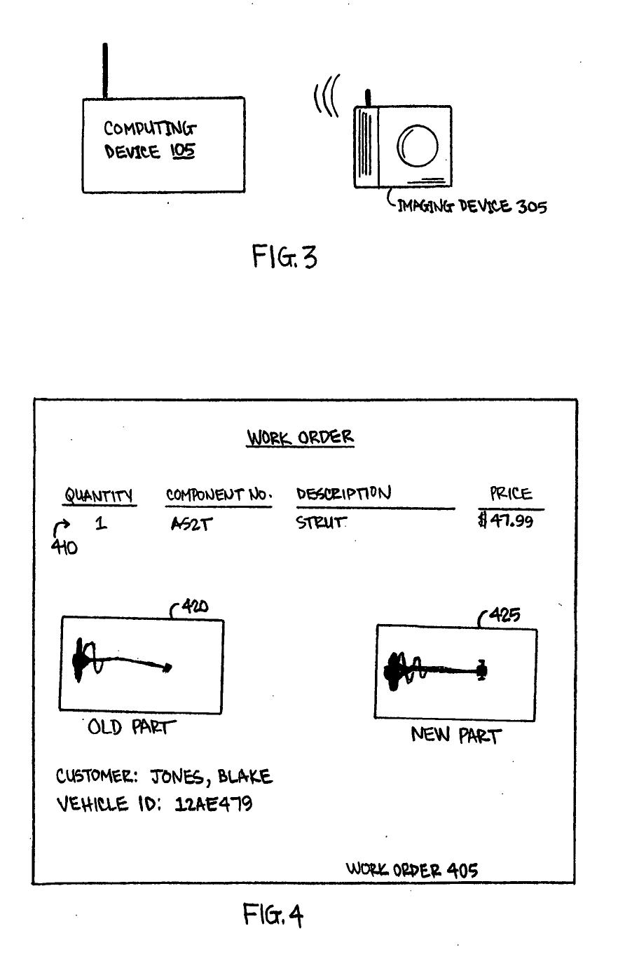

FIG. 4 illustrates an exemplary work order including images. The illustrated work order 405 includes a line item 410 showing the replacement of a suspension component. The work order also includes 405 a replaced component image 420 and a new component image 425. As one skilled in the art will appreciate, the images 420, 425 can be taken separately from the vehicle or in situ depending on the situation or preferences.

The work order 405 may be displayed on a display screen for customer viewing. Additionally, the work order 405 may be printed to generate a hardcopy record. Also, the work order 405 or the images 420, 425 associated therewith may be transmitted electronically to the customer or other requesting party.

One advantage of an embodiment of the present disclosure is that the images stored in the service database can be easily transmitted to an insurance provider or claims agent. Often for vehicle body repairs, the claims agent requires visual confirmation of the damage in order to authorize repairs or to approve the payment of completed repairs. An embodiment of the present disclosure provides a convenient technique for documenting the work performed on a vehicle. This documentation can be valuable for a variety of reasons, such as demonstrating to the customer the quality of work performed or protecting the service facility from expensive liability claims.

Having described embodiments of Service Database With Component Images (which are intended to be illustrative and not limiting), it is noted that modifications and variations can be made by persons skilled in the art in light of the above teachings. It is therefore to be understood that changes may be made in the particular embodiments disclosed that are within the scope and spirit of the present disclosure.

1. A vehicle service database stored in a computer-readable medium comprising:
a work order data structure reciting at least one component to be serviced, installed, replaced, or repaired; and
an image data structure for representing a digital image of the at least one component.

2. The medium of claim 1, wherein the work order data structure includes a link to the image data structure.

3. The medium of claim 1, wherein the image data structure includes a plurality of views of a replaced component.

4. The medium of claim 1, wherein the image data structure includes a replaced component image and a new component image.

5. The medium of claim 1, wherein the image data structure includes at least one in situ image.

6. The medium of claim 1, wherein the digital image comprises a video clip.

7. A vehicle diagnostic system comprising:
a computing device including a service database, the service database including a work order data structure reciting at least one component to be serviced, installed, replaced, or repaired and an image data structure for representing a digital image of the at least one component; and
an imaging device coupled to the computing device and configured to provide a digital image for storage into the service database.

8. The system of claim 7, wherein the work order data structure includes a link to the image data structure.

9. The system of claim 7, wherein the image data structure includes a replaced component.

10. The system of claim 7, wherein the image data structure includes a replaced component image and a new component image.

11. The system of claim 7, wherein the image data structure includes at least one in situ image.

12. A method for storing an image into a vehicle services database, the method comprising:
receiving image data from an imaging device;
associating the image data with a work order; and
storing the image data into the vehicle service database.

13. The method of claim 12, wherein the imaging device comprises a video camera and the image data comprises a video clip.

14. A method for providing visual confirmation of task completing to a requesting party, the method comprising:
accessing a work order associated with the task from a vehicle services database;
retrieving image data from the vehicle service database; and
providing the image data to the requesting party.

15. The method of claim 14, wherein the providing further includes:
sending the image data to the requesting party via electronic mail.

16. The method of claim 14, wherein the providing further includes:
transmitting the image data to the requesting party via a data network.

17. The method of claim 14, wherein the requesting party is an insurance provider or claims agent.
